(19) United States
(12) Patent Application Publication
(10) Pub. No.: US 2024/0410808 A1
(43) Pub. Date: Dec. 12, 2024

(54) SYSTEMS AND ASSEMBLIES FOR HOLDING TEST SAMPLES OF CONSOLIDATED POROUS MEDIA

(71) Applicant: TotalEnergies E&P Research & Technology USA, LLC, Houston, TX (US)

(72) Inventors: Sibani L. Biswal, Bellaire, TX (US); George J. Hirasaki, Bellaire, TX (US); Eric D. Vavra, Sugar Land, TX (US); Maura C. Puerto, Houston, TX (US); Khalid Mateen, Katy, TX (US); Kun Ma, Sugar Land, TX (US)

(73) Assignee: William Marsh Rice University, Houston, TX (US)

(21) Appl. No.: 18/701,382

(22) PCT Filed: Oct. 12, 2022
(86) PCT No.: PCT/US2022/046377

§ 371 Date: Apr. 15, 2024

Related U.S. Application Data
(60) Provisional application No. 63/256,411, filed on Oct. 15, 2021.

(51) Int. Cl. G01N 15/08

(52) U.S. Cl. CPC G01N 15/0806; G01N 15/0826

(57) ABSTRACT

A core holder assembly (100) for holding a test sample (200) including a consolidated porous medium includes an outer barrel including a central passage defined by an inner surface, a confining solid positioned in the central passage of the outer barrel, wherein the confining solid includes an outer surface sealed against the inner surface of the outer barrel and an inner surface, wherein the confining solid includes a rigid, lead-free material, and the test sample positioned within the confining solid, wherein the inner surface of the confining solid is sealed against an outer surface of the test sample.

### CROSS-REFERENCE TO RELATED APPLICATIONS

This application claims benefit of U.S. provisional patent application Ser. No. 63/256,411 filed Oct. 15, 2021, and entitled “Systems and Assemblies for Holding Test Samples of Consolidated Porous media,” which is hereby incorporated herein by reference in its entirety for all purposes.

### STATEMENT REGARDING FEDERALLY SPONSORED RESEARCH OR DEVELOPMENT

Not applicable.

### BACKGROUND

In many, varying applications it may be desirable to determine various properties of porous media, including consolidated porous media or rock such as, for example, sandstone. As an example, it may be desirable to determine various properties of consolidated porous media in civil and oil and gas applications including, for example, enhanced oil recovery (EOR) applications. Properties of interest in these and other applications may include, among other things, pressure drop across the porous media in response to fluid flow therethrough, as well as fluid saturations. In some applications, a core sample of or analogous to a natural environment of interest may be flooded with fluid in a laboratory as part of a “core flooding” experiment to simulate conditions resembling the natural environment of interest. Results of the core flooding experiment may, among other things, be used to determine how different fluids may travel through the natural environment of interest.

### SUMMARY

An embodiment of a core holder assembly for holding a test sample including a consolidated porous medium, the core holder assembly comprising an outer barrel comprising a central passage defined by an inner surface, a confining solid positioned in the central passage of the outer barrel, wherein the confining solid comprises an outer surface sealed against the inner surface of the outer barrel and an inner surface, wherein the confining solid comprises a rigid, lead-free material, and the test sample positioned within the confining solid, wherein the inner surface of the confining solid is sealed against an outer surface of the test sample. In some embodiments, the material comprising the confining solid comprises a metal alloy comprising bismuth and tin. In some embodiments, the metal alloy comprises a ratio by weight that ranges from 30:70 tin-to-bismuth to 50:50 tin-to-bismuth. In certain embodiments, the metal alloy comprises a ratio by weight ranging from 40:60 tin-to-bismuth to 45:55 tin-to-bismuth. In certain embodiments, the material comprising the confining solid has a melting temperature that is less than 300° F. In some embodiments, core holder assembly comprises an endcap coupled to a longitudinal end of the outer barrel, an annular first seal that seals between the endcap and the longitudinal end of the outer barrel, and an annular second seal that seals between the endcap and a longitudinal end of the confining solid. In some embodiments, core holder assembly comprises a pressure tap sealingly received in a radial aperture formed in the outer barrel, wherein the pressure tap is in fluid communication with a fluid disposed in the test sample. In certain embodiments, core holder assembly comprises a capillary pressure probe sealingly received in a radial aperture formed in the outer barrel, wherein the capillary pressure probe extends into the test sample. An embodiment of a system for performing experiments on the test sample, wherein the system comprises the core holder assembly, wherein the core holder assembly comprises a pressure tap sealingly received in a radial aperture of the outer barrel of the core holder assembly, a pump configured to supply a flow of fluid from a fluid source of the system to the core holder assembly, and an electronics package connected to the pressure tap and the capillary pressure probe of the core holder assembly, wherein the electronics package is configured to monitor a pressure of fluid in the test sample.

An embodiment of a core holder assembly for holding a test sample including a consolidated porous medium, the core holder assembly comprising an outer barrel comprising a central passage defined by an inner surface, a confining solid positioned in the central passage of the outer barrel, wherein the confining solid comprises an outer surface sealed against the inner surface of the outer barrel and an inner surface, wherein the confining solid comprises a metal alloy that includes bismuth and tin, and the test sample positioned in the confining solid, wherein the inner surface of the confining solid is sealed against an outer surface of the test sample. In some embodiments, the metal alloy comprises a ratio by weight of between 30:70 tin-to-bismuth and 50:50 tin-to-bismuth. In some embodiments, the metal alloy comprises a ratio by weight of between 40:60 tin-to-bismuth and 45:55 tin-to-bismuth. In certain embodiments, the material comprising the confining solid has a melting temperature that is less than 300° F. In certain embodiments, the outer surface of the test sample is coated by a sealant. In some embodiments, the metal alloy is configured to expand upon solidification. In some embodiments, core holder assembly comprises a pressure tap sealingly received in a radial aperture formed in the outer barrel, wherein the pressure tap is in fluid communication with a fluid disposed in the test sample. An embodiment of a system for performing experiments on the test sample, wherein the system comprises the core holder assembly, wherein the core holder assembly comprises a pressure tap sealingly received in a radial aperture of the outer barrel of the core holder assembly, a pump configured to supply a flow of fluid from a fluid source of the system to the core holder assembly, and an electronics package connected to the pressure tap and the capillary pressure probe of the core holder assembly, wherein the electronics package is configured to monitor a pressure of fluid in the test sample.

An embodiment of a method for forming a core holder assembly for holding a test sample including a consolidated porous medium, the method comprising (a) positioning the test sample within a central passage of an outer barrel, (b) flowing a lead-free material into an annulus formed between an outer surface of the test sample and an inner surface of the barrel, and (c) solidifying the material in the annulus to form a confining solid whereby the confining solid expands upon solidification such that an outer surface of the confining solid seals against the inner surface of the barrel and an inner surface of the confining solid seals against the outer surface of the test sample. In some embodiments, the material comprising the confining solid comprises a metal alloy which comprises bismuth and tin. In some embodiments, the material comprising the confining solid has a melting temperature that is less than 300 degrees Fahrenheit.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic view of an embodiment of a system for performing experiments on a test sample;

FIG. 2 is a side view of the core holder assembly of the system of FIG. 1;

FIG. 3 is a cross-sectional side view of the core holder assembly of FIG. 2;

FIG. 4 is an enlarged cross-sectional view of the core holder assembly of FIG. 2 taken in section 4-4 of FIG. 3;

FIG. 5 is another cross-sectional side view of the core holder assembly of FIG. 2; and

FIG. 6 is a flowchart of an embodiment of a method for forming a core holder assembly for holding a test sample comprising consolidated porous media.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, test samples in the form of rock core samples may be utilized in experiments sometimes referred to as “core flooding” experiments to simulate a natural environment of interest and thereby determine or predict properties of a porous media of the natural environment (e.g., a sandstone formation, etc.) including, among other things, how different fluids travel through the porous media. In at least some applications, a core sample comprising consolidated porous media may be placed within a core holder assembly and then positioned in an experimental apparatus including a heating device and a fluid transport device. Particularly, the heating device is used to heat the core sample to a temperature resembling the natural environment of interest while the fluid transport device is used to flow a fluid through the core sample under conditions similar to those of the natural environment of interest. Additionally, the fluids flowed through the core sample may resemble or be analogous to those existing in the natural environment of interest. The holder assembly may include one or more pressure sensors in fluid communication with the core sample whereby pressure at different locations along a longitudinal axis of the core sample may be monitored.

Conventional core sample holder assemblies may include a rubber sleeve in which the core sample is positioned. To ensure a seal between the rubber sleeve and core sample confining pressure in the form of pressurized water is exerted against an exterior of the rubber sleeve. The requirement of providing confining pressure against the rubber sleeve in-turn requires the addition of infrastructure to the experimental apparatus in the form of additional pumps, valves, fluid conduits, etc., increasing the expense associated with providing the experimental apparatus, reducing the reliability of the experimental apparatus, and increasing the complexity in operating the experimental apparatus during the performance of a core flooding experiment. Additionally, it may be difficult to form a reliable seal between the pressure sensors or probes of the holder assembly and the rubber sleeve, further increasing the difficulty in performing the core flooding experiment. Further, rubber sleeves may be unable to accommodate at least some corrosive fluids comparable to that encountered in some natural environments of interest. For example, it may be desired to flow supercritical carbon dioxide (CO2) through a core sample to mimic conditions in some natural environments. However, supercritical CO2 is destructive to rubber sleeves, and thus conventional core holder assemblies employing rubber sleeves cannot be utilized in such applications without first isolating rubber from contacting CO2.

Accordingly, embodiments disclosed herein include systems for performing experiments on test samples that comprising a core holder assembly including a non-toxic, phase-changing material. Embodiments of core holder assemblies disclosed herein may be particularly suited for conducting core flooding experiments performed on the test sample that comprise consolidated porous media. The test sample may be sealed within the core holder assembly by a confining solid comprising a non-toxic, phase-changing material. Particularly, the material comprising the confining solid may expand upon solidification to seal against the test sample without the need of applying a confining pressure to the confining solid, thereby simplifying the design of the core holder assembly as well as the system in which the core holder assembly is utilized. The material is also rigid following solidification, allowing for the convenient drilling of radial apertures therein in which pressure sensors or probes may be sealingly disposed. Additionally, as described above, the material comprising the confining solid is non-toxic, and thus does not include toxic materials such as, for example, lead. Instead, the material may comprise a phase-changing metal alloy having a relatively low melting temperature, and including tin and bismuth at varying ratios. Alternatively, the material forming the confining solid may comprise a nonmetallic material such as an epoxy resin which may be conveniently cured to form a solid thermosetting polymer or other thermoset material.

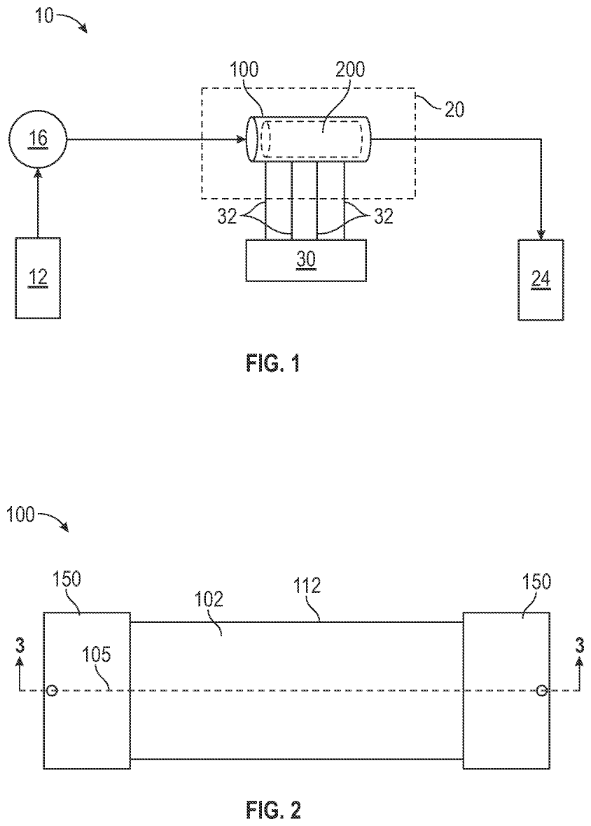

Referring now to FIG. 1, an embodiment of an experimental apparatus or system 10 for performing experiments on a test sample 200 is shown. In this exemplary embodiment, system 10 is configured to perform core flooding experiments on test sample 200, which comprises a porous media. Particularly, test sample 200 comprises consolidated porous media such as, for example, a consolidated rock (e.g., sandstone, etc.) core sample. Thus, test sample 200 may also be referred to herein as core 200 or core sample 200. However, in other embodiments, the type of test sample 200 employed by system 10 may vary. Additionally, the test sample 200 may comprise an analog core sample intended to mimic porous media of a natural environment of interest. System 10 is utilized to determine various properties of test sample 200 including, among other things, how different fluids travel through the test sample 200. As used herein, the term “unconsolidated” porous media refers to porous media comprising separate and distinct grains such as, for example, sand while the term “consolidated” porous media refers to porous media comprising grains which are chemically cemented together such as, for example, sandstone.

In this exemplary embodiment, system 10 generally includes a fluid source 12, a pump 16, a heating device 20, a core holder assembly 100 housing the test sample 200, a fluid return 24, and an electronics package 30. System 10 is only shown schematically in FIG. 1, and thus may include features not illustrated in FIG. 1. System 10 is generally configured to flow a fluid from the fluid source 12 through the test sample 200 while monitoring one or more parameters of the test sample 200 using the electronics package 30 of system 10. In some embodiments, fluid source 12 includes one or more separate accumulators storing separate fluids that are mixed prior to being delivered to the test sample 200; however, in other embodiments, the configuration of fluid source 12 may vary. The fluid delivered to the test sample 200 from fluid source 12 may comprise two or more immiscible phases (e.g., gas and liquid, etc.). Additionally, the fluid delivered to test sample 200 may be the same as or analogous to the fluid contained in the natural environment of interest. Thus, the fluid delivered to test sample 200 may comprise corrosive fluids including, for example, supercritical CO₂. As will be described further herein, core holder assembly 100 is made of materials configured to withstand contact with corrosive fluids including, among others, supercritical CO₂.

Pump 16 of system 10 pumps the fluid from fluid source 12 into and through the test sample 200 housed within core holder assembly 100. In general, pump 16 may comprise any suitable device for producing a flow of fluid. After flowing through test sample 200, the fluid is delivered to fluid return 24 of system 10. In some embodiments, the fluid, having flowed through test sample 200, may return to the fluid source 12. Additionally, various valves may be connected between fluid source 12, pump 16, and fluid return 24 of system 10 to control the flow of the fluid therebetween. In this exemplary embodiment, core holder assembly 100 and test sample 200 are each positioned within heating device 20, thereby allowing heating device 20 to maintain test sample 200 and/or the fluid delivered to test sample 200 from fluid source 12 at a desired temperature. In some embodiments, the temperature maintained by heating device 20 may be an elevated temperature intended to mimic conditions within a subterranean hydrocarbon bearing reservoir. In some embodiments, the temperature may range approximately between 90 degrees Celsius (° C.) to 300° C.; however, it may be understood that the temperature maintained by heating device 20 may vary. Additionally, the temperature maintained by heating device 20 is less than a melting temperature of the materials comprising the core holder assembly 100. Heating device 20 may comprise a convection oven, but in general, heating device 20 may be any suitable device for controlling the temperature of test sample 200 and/or the fluid delivered to test sample 200. Additionally, system 10 may include a fluid pressure regulator located between core holder assembly 100 and fluid return 24 to maintain a desired pressure of the fluid exiting the core holder assembly 100. As will be described further herein, core holder assembly 100 is made of materials and is generally configured to withstand elevated temperatures and/or pressures that may be found in some natural environments, maximizing the utility and flexibility of system 10 in performing experiments mimicking conditions of a wide variety of natural environments.

In this exemplary embodiment, the electronics package 30 of system 10 comprises one or more sensors configured to determine and monitor one or more parameters of test sample 200 during the performance of a test conducted by system 10. For example, electronics package 30 can monitor differential pressure along a length of a central or longitudinal axis 205 of test sample 200. Electronics package 30 can also monitor capillary pressure at one or more locations along the longitudinal length of test sample 200. In this embodiment, electronics package 30 is coupled to the core holder assembly 100 by one or more fluid conduits 32 extending therebetween. It may also be understood parameters monitored by electronics package 30 may vary depending on the given application.

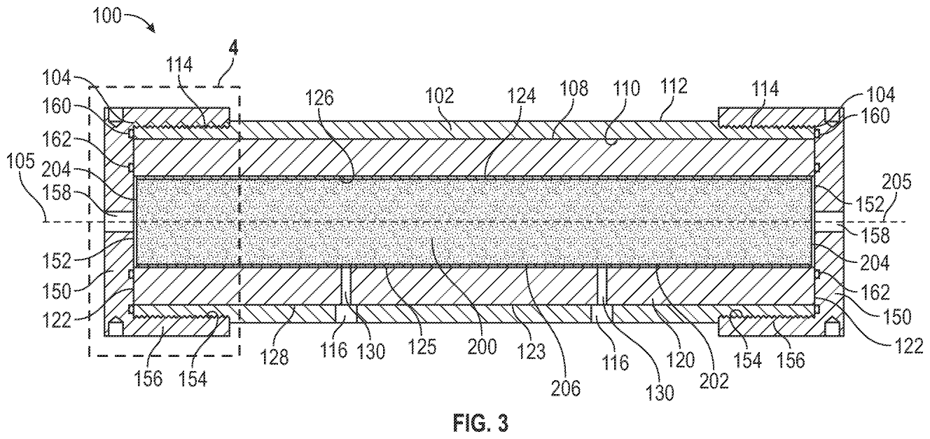

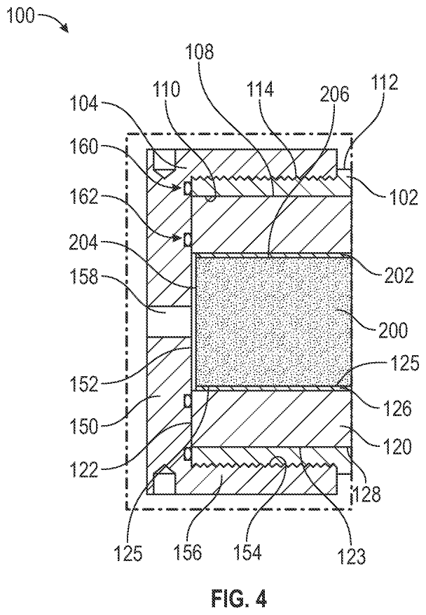

Referring now to FIGS. 2-4, an embodiment of the core holder assembly 100 is shown. As described above, core holder assembly 100 receives test sample 200 and is utilized as a component of an experimental apparatus such as, for example, system 10. While core holder assembly 100 is shown as a component of system 10 of FIG. 1, it may be understood that core holder assembly 100 may be utilized in other systems or apparatuses which may vary significantly from that shown in FIG. 1.

In this exemplary embodiment, test sample 200 is generally cylindrical having an outer cylindrical surface 202 extending between a pair of opposed longitudinal ends 204. As described above, in this exemplary embodiment, test sample 200 comprises a consolidated porous material such as, for example, sandstone. In other embodiments, the shape of test sample 200 may vary from that shown in FIGS. 2-4. For example, a cross-sectional profile of test sample 200 may vary whereby test sample 200 could have a rectangular cross-section, for example. Indeed, in contrast to conventional core holders, core holder assembly 100 may conveniently accommodate test samples 200 of practically any shape.

In this exemplary embodiment, core holder assembly 100 has a central or longitudinal axis 105 and generally includes an outer housing or barrel 102, an inner confining solid 120, and a pair of opposing collars or endcaps 150. Central axis 105 of core holder assembly 100 is coaxially aligned with the central axis 205 of test sample 200 in this exemplary embodiment but may be offset in other embodiments. In this exemplary embodiment, a coating or sealant 206 is applied to the test sample 200 to seal the test sample 200, and thereby prevent material from the to-be-formed confining solid 120 from flowing into pores of the test sample 200 during the assembly of core holder assembly 100. In this configuration, coating 206 comprises or defines the outer surface 202 of test sample 200. In this exemplary embodiment, coating 206 comprises a composite material such as, for example, a composite material including a resin (e.g., epoxy, etc.) and sand; however, in other embodiments, the configuration of coating 206 may include any coating that sticks to the outer surface 202 of the test sample 200 but does not penetrate into the pores of the test sample 200 and which is compatible with the fluid delivered to test sample 200. For example, the coating 206 may comprise various types of viscous curing polymers or resins such as, for example, slush latex, resign glue, acrylic resin, and polyester resin. In still other embodiments, a coating or sealant may not be applied to the test sample 200.

The barrel 102 of core holder assembly 100 retains the confining solid 120 and test sample 200, and provides a member to which the endcaps 150 may couple. Barrel 102 has a pair of opposed longitudinal end 104, a central bore or passage 108 defined by a generally cylindrical inner surface 110 extending axially between ends 104, and a generally cylindrical outer surface 112 also extending axially between ends 104. In this exemplary embodiment, the outer surface 112 of barrel 102 comprises a releasable or threaded connector 114 formed at each end 104 thereof for releasably coupling the barrel 102 with endcaps 150.

Additionally, in this exemplary embodiment, barrel 102 comprises one or more radial apertures or openings 116, each of which extend radially entirely through the barrel 102 from inner surface 110 to outer surface 112. Although only two radial apertures 116 are shown in FIG. 2, the number of radial apertures 116 may vary depending on the given application. As will be discussed further herein, radial apertures 116 allow for the installation of pressure taps and/or pressure probes connected to the electronics package 30 of system 10. In other words, radial apertures 116 provide access to the central passage 108 of barrel 102 whereby parameters of test sample 200 may be monitored using electronics package 30.

Barrel 102 is made of a durable material that may be subjected to elevated temperatures and/or pressures without becoming damaged or otherwise compromised such that conditions of a wide variety of natural environments of interest may be accurately replicated by system 10. Additionally, in some embodiments, barrel 102 may be made of a corrosion resistant material. In this exemplary embodiment, barrel 102 is formed from or comprises a metallic material such as, for example, a stainless-steel alloy. However, in other embodiments, barrel 102 may comprise superalloys such as, for example, Monel®, Hastelloy®, Inconel®. In other embodiments, barrel 102 may comprise carbon steels (e.g., for non-corrosive applications), titanium, brass, bronze, copper, as well as nonmetallic materials such as, for example, polyether ether ketone (PEEK), epoxy, carbon fiber, fiberglass, etc.

Confining solid 120 is located within an annulus radially disposed between test sample 200 and barrel 102, and is generally configured to seal against a cylindrical outer surface 202 of the test sample 200 as fluid is flowed through test sample 200 from fluid source 12 of system 10 without the requirement of applying confining pressure to the confining solid 120. In this exemplary embodiment, confining solid 120 comprises a pair of opposed longitudinal ends 122, a central bore or passage 124 defined by a generally cylindrical inner surface 126 extending axially between ends 122, and a generally cylindrical outer surface 128 also extending axially between ends 122.

In this configuration, an annular first or radially outer interface 123 is formed radially between the inner surface 110 of barrel 102 and the outer surface 128 of confining solid 120. Additionally, an annular second or radially inner interface 125 is formed radially between the outer surface 202 of test sample 200 and the inner surface 126 of confining solid 120. As will be described further herein, each interface 123, 125 is sealed along the entire longitudinal length of each interface 123, 125 without the need for applying confining pressure to the confining solid 120. Instead, the outer surface 128 of confining solid 120 sealingly contacts the inner surface 110 of barrel 102 while the inner surface 126 of confining solid 120 sealingly contacts the outer surface of test sample 200, thereby sealing the test sample 200 within core holder assembly 100. Particularly, the sealing contact between confining solid 120 and both barrel 102 and test sample 200 may extend axially substantially along the entirety of the longitudinal length of the confining solid 120, thereby preventing fluid communication axially through the interfaces 123, 125.

Confining solid 120 is made of or comprises a rigid, phase-changing material such as a thermoset material or a material having a relatively low melting temperature. For example, confining solid 120 may comprise a thermoset material such as an epoxy resin or a metallic material having a low melting temperature. The material of confining solid 120 being a phase-changing material (e.g., a thermoset material, a metallic material having a low melting temperature, etc.) may aid in the convenience and minimize the costs associated with assembling core holder assembly 100 with test sample 200. In embodiments where the material comprising confining solid 120 is a metallic material, the metallic material may have a melting temperature less than 200° C.; however, in other embodiments, the melting temperature of confining solid 120 may vary. The melting temperature of the metallic material will be greater than the temperature of the natural environment of interest. For example, in an application where the natural environment of interest is a subterranean oil reservoir, the material comprising confining solid 120 may comprise a metallic material having a melting temperature greater than the temperature of the oil reservoir. Additionally, the material forming confining solid 120 may expand upon solidification. The expansion of confining solid 120 upon solidification forms the seal between confining solid 120 and both the outer barrel 102 and test sample 200, thereby sealing test sample 200 within core holder assembly 100.

Further, the material forming confining solid 120 is a non-toxic material that is safe to handle by personnel responsible for assembling core holder assembly 100 and/or operating system 10 to conduct experiments utilizing core holder assembly 100. In particular, confining solid 120 does not include toxic materials such as, for example, lead, which may be hazardous to personnel handling core assembly 100. Thus, in at least some embodiments, confining solid 120 is made of a lead-free material. The material forming confining solid 120 may comprise an alloy formed from one or more post-transition metals. Particularly, in this exemplary embodiment, confining solid 120 is made of a lead-free, tin or bismuth-based metal alloy. For example, confining solid 120 may comprise a metal alloy including tin and bismuth in a ratio (by weight %) ranging from 30:70 tin-to-bismuth to 50:50 tin-to-bismuth. In some embodiments, confining solid 120 is made of a metal alloy including tin and bismuth in a ratio (by weight %) ranging from 40:60 tin-to-bismuth to 45:55 tin-to-bismuth; however, in other embodiments, the relative amounts of bismuth and tin may vary. For example, in some embodiments, the phase-changing material comprising confining solid 120 may comprise pure bismuth, an indium-containing alloy, lead-free Babbit alloy, an epoxy resin that expands upon curing. In still other embodiments, the phase-changing material may not comprise a material that expands upon solidification or curing such as, for example, a lead-free pewter material, pure tin, an epoxy-sand composite, an epoxy-graphite composite, an epoxy-carbon fiber composite, or a rubber having a Shore hardness greater than 80. In such embodiments a vacuum may be applied during the solidification/curing of the material to allow the phase-changing material to entirely fill the annulus formed radially between test sample 200 and barrel 102 such that no voids are present within the annulus.

In this exemplary embodiment, confining solid 120 comprises one or more radial apertures or openings 130, each of which extend entirely between the inner surface 126 and outer surface 128 of confining solid 120. Although only two radial apertures 130 are shown in FIG. 2, the number of radial apertures 130 may vary depending on the given application. Additionally, each radial aperture 130 of confining solid 120 is axially and circumferentially aligned with a corresponding radial aperture 116 of barrel 102. As will be discussed further herein, radial apertures 116 allow for the installation of pressure taps and/or pressure probes connected to the electronics package 30 of system 10. In other words, radial apertures 116 provide access to the central passage 108 of barrel 102 whereby parameters of test sample 200 may be monitored by electronics package 30.

Endcaps 150 are coupled to the opposing ends 104 of barrel 102 to seal test sample 200 within core holder assembly 100 and to provide a means for communicating the fluid from fluid source 12 to the test sample 200. In this exemplary embodiment, each endcap 150 generally includes a cylindrical receptacle defined by an inner planar surface 152 and an inner cylindrical surface 154 extending axially from the planar surface 152. The cylindrical surface 154 of each endcap 150 comprises a releasable or threaded connector 156 formed thereon for releasably or threadably coupling to one of the connectors 114 of barrel 102. In some embodiments, each endcap 150 may be threaded onto the barrel 102 manually using, for example, a tool or wrench to engage an outer surface of the endcap 150. However, a variety of mechanisms may be employed to releasably or permanently connect endcaps 150 to barrel 102. Each endcap 150 additionally includes a central port 158 which extends axially therethrough from the planar surface 152 of the endcap 150. Fluid from fluid source 12 flows into and from core holder assembly 100 via the central ports 158 of endcaps 150. Thus, central ports 158 are fluidically connected to the fluid source 12 and fluid return 24 of system 10 via one or more fluid conduits.

In this exemplary embodiment, an annular radially outer or backup seal 160 and an annular radially inner seal 162 are positioned on the planar surface 152 of each endcap 150. Particularly, outer seal 160 sealingly contacts planar surface 152 of endcap 150 and one of the ends 104 of barrel 102, thereby sealing the annular interface formed between the endcap 150 and barrel 102. Additionally, inner seal 162 sealingly contacts planar surface 152 of endcap 150 and one of the ends 122 of confining solid 120, thereby sealing the annular interface formed between the endcap 150 and confining solid 120. In this exemplary embodiment, seals 160, 162 comprise O-ring seals that are compressed as the endcap 150 is threaded onto the barrel 102; however, in other embodiments, mechanisms other than O-ring seals may be utilized to seal the interfaces between the planar surface 152 of each endcap 150 and the barrel 102 and confining solid 120.

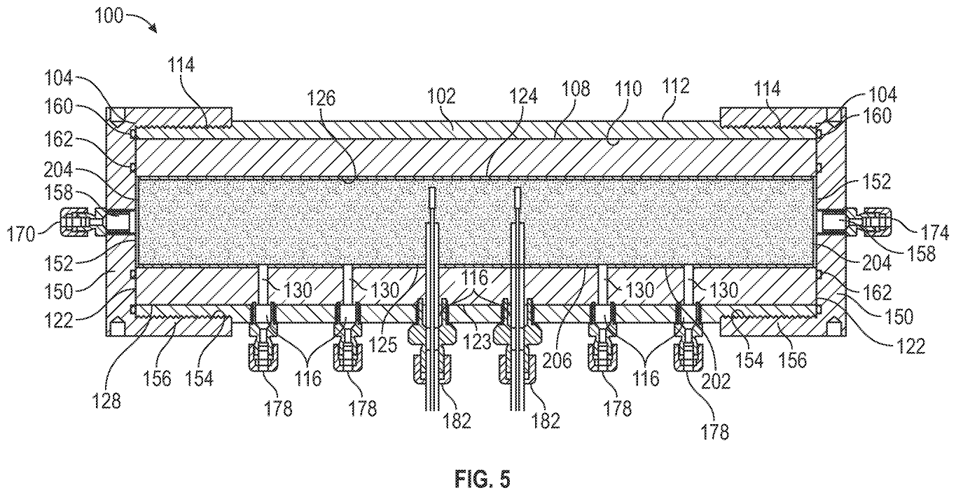

Referring now to FIG. 5, core holder assembly 100 is shown in a fully assembled configuration including a set of exemplary sealed fluid connections provided between core holder assembly 100 and other components of system 10. In this exemplary embodiment, core holder assembly 100 comprises a fluid inlet connector 170, a fluid outlet connector 174, a plurality of pressure taps or sensor connectors 178, and a pair of capillary pressure probes or sensors 182. Fluid inlet connector 170 and fluid outlet connector 174 are sealingly coupled to the central ports 158 of endcaps 150 and are fluidically connected to the fluid source 12 and fluid return 24, respectively, by one or more fluid conduits. Annular seals or other sealing mechanisms of fluid inlet connector 170 and fluid outlet connector 174 may be utilized to seal the interfaces between fluid inlet connector 170, fluid outlet connector 174, and endcaps 150. In this exemplary embodiment, a metal-to-metal seal (e.g., a ferrule or Swagelok® seal, etc.) is provided between the connectors 170, 174 and central ports 158 of endcaps 150; however, it may be understood that the configuration of the sealed connection provided between connectors 170, 174 and central ports 158 may vary.

Pressure sensor connectors 178 are sealingly coupled to the radial apertures 116 of barrel 102. An annular seal or other sealing mechanism of pressure sensor connectors 178 can be utilized to seal the interface between pressure sensor connectors 178 and barrel 102. Given the sealing contact between the outer surface 128 of confining solid 120 and the inner surface 110 of barrel 102, an additional seal is unnecessary to seal the interface formed between each radial aperture 116 of barrel 102 and the corresponding radial aperture 130 of confining solid 120 aligned with the radial aperture 116. Pressure sensor connectors 178 are fluidically connected via a plurality of corresponding fluid conduits to electronics package 30 of system 10. With pressure sensor connectors 178 each in fluid communication with the fluid flowing through test sample 200, fluid pressure may be monitored at a plurality of locations spaced along the longitudinal length of test sample 200. This information may be utilized to determine a fluid pressure drop longitudinally across the test sample 200 as well as other parameters of test sample 200.

Capillary pressure probes 182 are also sealingly coupled to the radial apertures 116 of barrel 102 via annular seals or other conventional sealing mechanisms of capillary pressure probes 182. In this manner, and in contrast to conventional sleeved (e.g., including a rubber sleeve sealed with confining pressure) core holders, a leak-tight connection may be conveniently and reliably formed between each capillary pressure probe 182 and both the barrel 102 and confining solid 120. Additionally, capillary pressure probes 182 extend into and through the radial apertures 130 of confining solid 120 such that capillary pressure probes 182 terminate within the test sample 200 itself. In this manner, capillary pressure probes 182 may monitor capillary pressure in the test sample 200 at different locations along the longitudinal length thereof. Capillary pressure may be communicated from capillary pressure probes 182 to a pair of differential pressure transducers of electronics package 30, where each capillary pressure probe 182 is fluidically connected to the electronics package 30 via a pair of fluid conduits.

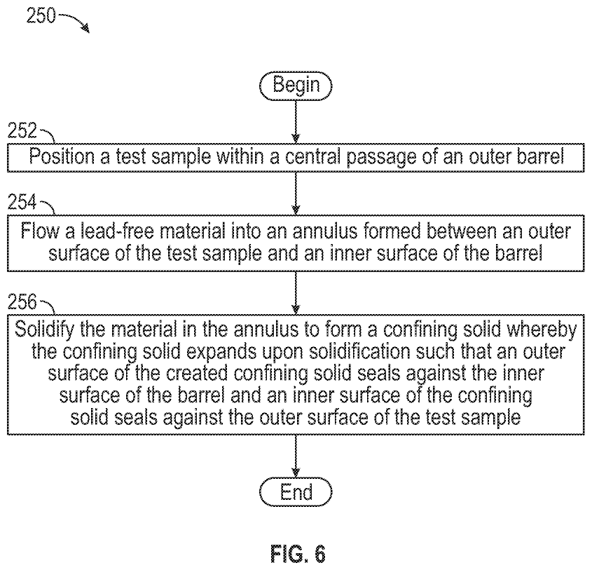

Referring to FIG. 6, an embodiment of a method 250 for forming a core holder assembly for holding a test sample comprising consolidated porous media is shown. Beginning at block 252, method 250 comprises positioning the test sample within a central passage of an outer barrel. In some embodiments, block 252 comprises positioning test sample 200 within the central passage 108 of the outer barrel 102 of core holder assembly 100 shown in FIGS. 2-5. In some embodiments, test sample 200 may be cut to a predefined longitudinal length the same or similar as the longitudinal length of barrel 102 prior to being positioned within barrel 102. In some embodiments, the outer surface 202 of test sample 200 may be coated by the coating or sealant 206 prior to being inserted into the barrel 102.

At block 254, method 250 comprises flowing a lead-free material into an annulus formed between an outer surface of the test sample and an inner surface of the barrel. In some embodiments, block 254 comprises flowing, as a liquid, the material comprising the confining solid 120 of core holder assembly 100 into the annulus formed radially between test sample 200 and barrel 102. In some embodiments, the liquid material flowed into the annulus at block 254 comprises or is a metal alloy which comprises bismuth and tin. For example, the metal alloy may comprise a ratio (by weight %) of between 30:70 tin-to-bismuth and 50:50 tin-to-bismuth. Alternatively, the metal alloy may comprise a ratio (by weight %) of between 40:60 tin-to-bismuth and 45:55 tin-to-bismuth. In some embodiments, the liquid material flowed into the annulus at block 254 may have a melting temperature that is less than 300° F.

At block 256, method 250 comprises solidifying the material in the annulus to form a confining solid whereby the confining solid expands upon solidification such that an outer surface of the created confining solid seals against the inner surface of the barrel and an inner surface of the confining solid seals against the outer surface of the test sample. In some embodiments, block 256 comprises solidifying the material comprising confining solid 120 of core holder assembly 100 to thereby form confining solid 120 whereby the confining solid 120 expands upon solidification such that the outer surface 128 of confining solid 120 seals against the inner surface 110 of barrel 102 and the inner surface 126 of confining solid 120 seals against the outer surface 202 of test sample 200. In some embodiments, a volume of the confining solid 120 expands approximately between 1% and 5% upon solidification. In some embodiments, the material comprising the confining solid comprising a lead-free, non-toxic metal alloy. Alternatively, the formation of the confining solid may comprise a molding process (e.g., an injection molding process) where the confining solid comprises a nonmetallic material such as, for example, an epoxy resin.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A core holder assembly for holding a test sample including a consolidated porous medium, the core holder assembly comprising:
an outer barrel comprising a central passage defined by an inner surface;
a confining solid positioned in the central passage of the outer barrel, wherein the confining solid comprises an outer surface sealed against the inner surface of the outer barrel and an inner surface, wherein the confining solid comprises a rigid, lead-free material comprising a metal alloy including bismuth and tin in a ratio by weight ranging from 40:60 tin-to-bismuth to 45:55 tin-to-bismuth; and
the test sample positioned within the confining solid, wherein the inner surface of the confining solid is sealed against an outer surface of the test sample.

2. (canceled)

3. (canceled)

4. (canceled)

5. The core holder assembly of claim 1, wherein the material comprising the confining solid has a melting temperature that is less than 300° F.

6. The core holder assembly of claim 1, further comprising:
an endcap coupled to a longitudinal end of the outer barrel;
an annular first seal that seals between the endcap and the longitudinal end of the outer barrel; and
an annular second seal that seals between the endcap and a longitudinal end of the confining solid.

7. The core holder assembly of claim 1, further comprising a pressure tap sealingly received in a radial aperture formed in the outer barrel, wherein the pressure tap is in fluid communication with a fluid disposed in the test sample.

8. The core holder assembly of claim 1, further comprising a capillary pressure probe sealingly received in a radial aperture formed in the outer barrel, wherein the capillary pressure probe extends into the test sample.

9. A system for performing experiments on the test sample of claim 1, wherein the system comprises:
the core holder assembly claim 1, wherein the core holder assembly comprises a pressure tap sealingly received in a radial aperture of the outer barrel of the core holder assembly, and a capillary pressure probe sealingly received in the radial aperture formed in the outer barrel, wherein the capillary pressure probe extends into the test sample;
a pump configured to supply a flow of fluid from a fluid source of the system to the core holder assembly; and
an electronics package connected to the pressure tap and the capillary pressure probe of the core holder assembly, wherein the electronics package is configured to monitor a pressure of fluid in the test sample.

10. A core holder assembly for holding a test sample including a consolidated porous medium, the core holder assembly comprising:
an outer barrel comprising a central passage defined by an inner surface;
a confining solid positioned in the central passage of the outer barrel, wherein the confining solid comprises an outer surface sealed against the inner surface of the outer barrel and an inner surface, wherein the confining solid comprises a metal alloy that includes bismuth and tin in a ratio by weight ranging from 40:60 tin-to-bismuth to 45:55 tin-to-bismuth; and
the test sample positioned in the confining solid, wherein the inner surface of the confining solid is sealed against an outer surface of the test sample.

11. (canceled)

12. (canceled)

13. The core holder assembly of claim 10, wherein the material comprising the confining solid has a melting temperature that is less than 300° F.

14. The core holder assembly of claim 10, wherein the outer surface of the test sample is coated by a sealant.

15. The core holder assembly of claim 10, wherein the metal alloy is configured to expand upon solidification.

16. The core holder assembly of claim 10, further comprising a pressure tap sealingly received in a radial aperture formed in the outer barrel, wherein the pressure tap is in fluid communication with a fluid disposed in the test sample.

17. A system for performing experiments on the test sample of claim 10, wherein the system comprises:
the core holder assembly of claim 10, wherein the core holder assembly comprises a pressure tap sealingly received in a radial aperture of the outer barrel of the core holder assembly, and a capillary pressure probe sealingly received in the radial aperture formed in the outer barrel, wherein the capillary pressure probe extends into the test sample;
a pump configured to supply a flow of fluid from a fluid source of the system to the core holder assembly; and
an electronics package connected to the pressure tap and the capillary pressure probe of the core holder assembly, wherein the electronics package is configured to monitor a pressure of fluid in the test sample.

18. A method for forming a core holder assembly for holding a test sample including a consolidated porous medium, the method comprising:
(a) positioning the test sample within a central passage of an outer barrel;
(b) flowing a lead-free material into an annulus formed between an outer surface of the test sample and an inner surface of the barrel; and
(c) solidifying the material in the annulus to form a confining solid whereby the confining solid expands upon solidification such that an outer surface of the confining solid seals against the inner surface of the barrel and an inner surface of the confining solid seals against the outer surface of the test sample, the confining solid comprising a metal alloy including bismuth and tin in a ratio by weight ranging from 40:60 tin-to-bismuth to 45:55 tin-to-bismuth.

19. (canceled)

20. The method of claim 18, wherein the material comprising the confining solid has a melting temperature that is less than 300 degrees Fahrenheit.
